(19) United States
(12) Patent Application Publication
(10) Pub. No.: US 2022/0091481 A1
(43) Pub. Date: Mar. 24, 2022

(54) CAMERA DEVICE AND ELECTRONIC EQUIPMENT HAVING THE CAMERA DEVICE

(71) Applicant: TRIPLE WIN TECHNOLOGY(SHENZHEN) CO.LTD., Shenzhen (CN)

(72) Inventors: JIAN-CHAO SONG, Shenzhen (CN); JING-WEI LI, Shenzhen (CN); SHENG-JIE DING, Shenzhen (CN); DING-NAN HUANG, New Taipei (TW); SHIN-WEN CHEN, Tu-Cheng (TW)

(21) Appl. No.: 17/411,249

(22) Filed: Aug. 25, 2021

(30) Foreign Application Priority Data
Sep. 21, 2020 (CN) 202022078422.4

(51) Int. Cl. G03B 17/12; G03B 30/00; H04N 5/225

(52) U.S. Cl. CPC G03B 17/12; H04N 5/2253; H04N 5/2254; G03B 30/00

(57) ABSTRACT

A camera device includes a lens assembly, a substrate assembly, and a bearing assembly. The bearing assembly includes a bearing seat, a filter, and a first adhesive layer. A protrusion protrudes from a first side of the bearing seat. A second side of the bearing seat facing away from the first side of the bearing seat is connected to the lens assembly. A through groove penetrates the first side of the bearing seat and the second side of the bearing seat. The filter is received in the through groove. The first adhesive layer is formed on the protrusion to fix the protrusion on the substrate assembly. An electronic equipment is also provided.

### FIELD

The subject matter herein generally relates to a field of photography, in particular to a camera device and an electronic equipment having the camera device.

### BACKGROUND

With the continuous improvement of the pixels of the camera module of the electronic equipment, the package size of the photosensitive chip of the camera module is continuously increasing, resulting in the size of the filter of the camera module also increasing. As the size of the filter increases, the risk of filter breakage is also increasing.

Therefore, there is room for improvement within the art.

### BRIEF DESCRIPTION OF THE DRAWINGS

Implementations of the present disclosure will now be described, by way of embodiments, with reference to the attached figures.

FIG. 1 is a diagram of an embodiment of an electronic equipment according to the present disclosure.

FIG. 2 is a diagram of an embodiment of a camera device according to the present disclosure.

FIG. 3 is an exploded, diagrammatic view of an embodiment of a camera device according to the present disclosure.

FIG. 4 is a diagram of an embodiment of a bearing seat according to the present disclosure.

FIG. 5 is a cross-sectional view of the camera device taken along IV-IV line of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

An embodiment of a camera device includes a lens assembly for imaging, a bearing assembly, and a substrate assembly. The substrate assembly connects the bearing assembly and other electronic elements. The bearing assembly includes a bearing seat, a filter, and a first adhesive layer. One side of the bearing seat is connected to the lens assembly, and the other side of the bearing seat facing away from the lens assembly is provided with a protrusion. The protrusion is against the substrate assembly. The filter is received in the bearing seat. The first adhesive layer is formed on the protrusion to support the protrusion and fix the protrusion to the substrate assembly.

The camera device is applied in an electronic equipment. The electronic equipment further includes a main body. The camera device is received in the main body.

In the above camera device, the stability of the bearing seat is improved and the resonance between the bearing seat and the substrate assembly is eliminated by arranging the protrusion on the bearing seat and arranging the first adhesive layer on the protrusion. So that the breakage risk of the filter is effectively reduced.

In the following, some embodiments of the disclosure will be described in detail with reference to the accompanying drawings.

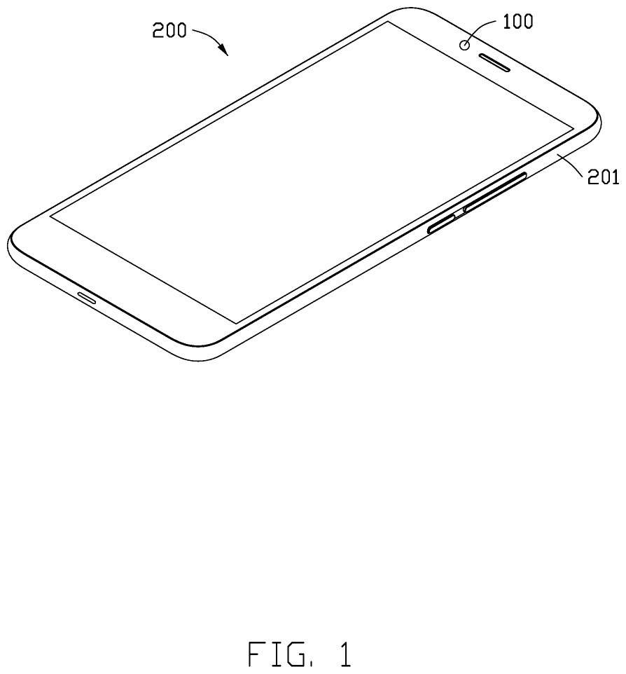

FIG. 1 illustrates an embodiment of an electronic equipment 200. The electronic equipment 200 includes a main body 201 and a camera device 100 mounted in the main body 201 for taking photos and videos. In at least one embodiment, the camera device 100 may be mounted on the front of the main body 201 or the back of the main body 201. In at least one embodiment, the camera device 100 may be received in the main body 201 in a retractable manner.

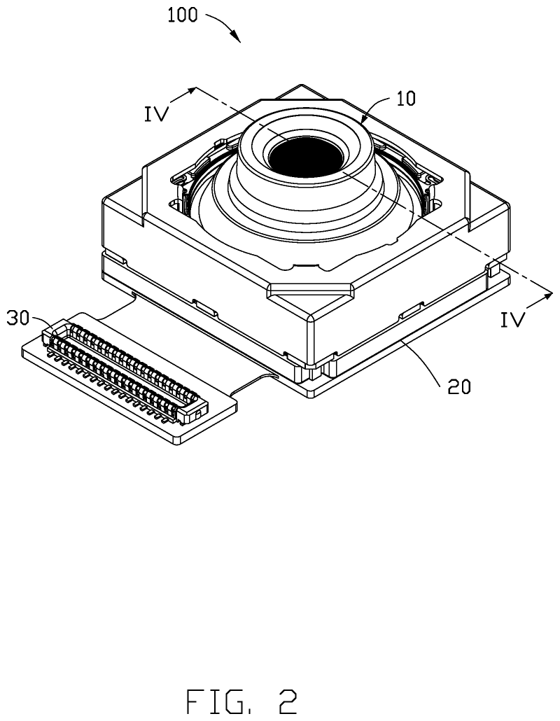

Referring to FIG. 1 and FIG. 2, the camera device 100 includes a lens assembly 10, a bearing assembly 20, and a substrate assembly 30. The bearing assembly 20 connects the lens assembly 10 and the substrate assembly 30. The substrate assembly 30 is connected to the main body 201.

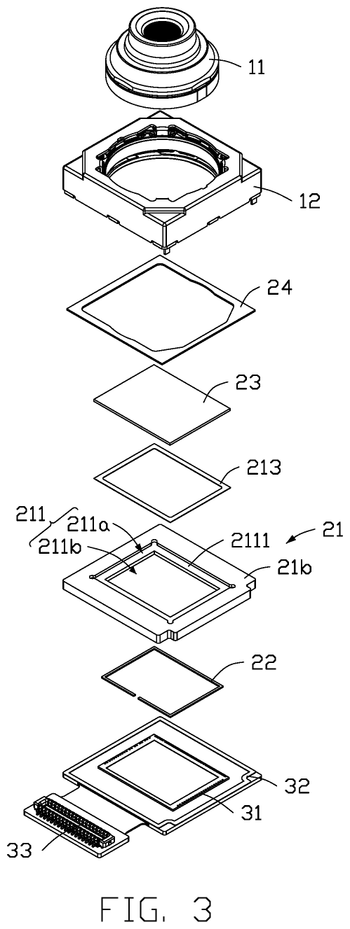

Referring to FIG. 3, the lens assembly 10 includes a lens 11 and an adjusting mechanism 12. The lens 11 is installed on the adjusting mechanism 12. In at least one embodiment, the adjusting mechanism 12 may be voice coil motor used to adjust the position of the lens 11 to realize an auto-focus function to present a clear image. In at least one embodiment, the adjusting mechanism 12 is covered by a cushioning foam (not shown).

The bearing assembly 20 includes a bearing base 21, a first adhesive layer 22, a filter 23, and a second adhesive layer 24. The filter 23 is mounted in the bearing base 21. The first adhesive layer 22 and the second adhesive layer 24 are respectively located on opposite sides of the bearing base 21. The first adhesive layer 22 is connected to the substrate assembly 30, and the second adhesive layer 24 is connected to the adjusting mechanism 12.

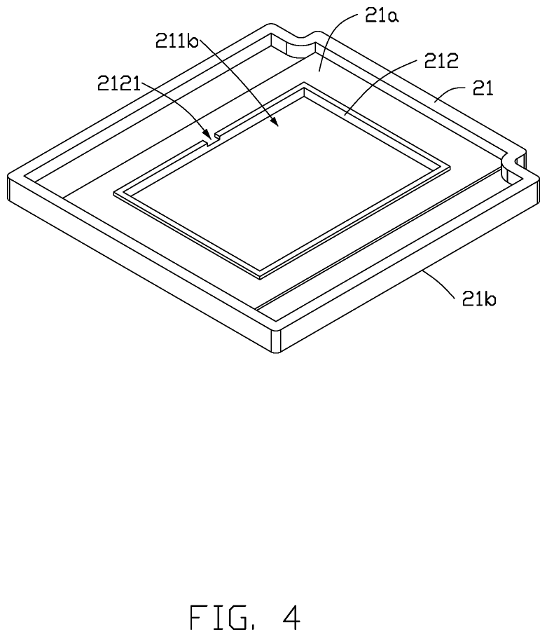

Referring to FIG. 3 and FIG. 4, a through groove 211 penetrates the bearing seat 21 for installing the filter 23. Specifically, the bearing base 21 includes a first side 21a and a second side 21b facing away from the first side 21a. The through groove 211 extends through the first side 21a and the second side 21b. A protrusion 212 protrudes from the first side 21a along an inner wall surrounding the through groove 211 in a direction away from the second side 21b.

The through groove 211 is a stepped groove and includes a stepped surface 2111. The filter 23 is received in the through groove 211 and supported by the stepped surface 2111. The through groove 211 includes a first recess 211a recessed from the second side 21b and a second recess 211b recessed from the first side 21a and communicating with the first recess 211a. The stepped surface 2111 is connected to a first inner surface forming the first recess 211a and a second inner surface forming the second recess 211b. The filter 23 is received in the first recess 211a. The protrusion 212 is arranged around the second recess 211b.

In at least one embodiment, a gasket 213 may be received in the through groove 211 and located between the filter 23 and the stepped surface 2111 to buffer the filter 23 and prevent the filter 23 from being broken. In at least one embodiment, a depth of the first recess 211a may be equal to a total thickness of the filter 23 and the gasket 213.

The first adhesive layer 22 is formed on a side of the protrusion 212 facing away from the through groove 211 to fix the protrusion 212 to the substrate assembly 30. The stability of the bearing seat 21 is improved and the resonance between the bearing seat 21 and the substrate assembly 30 is eliminated by arranging the protrusion 212 and the first adhesive layer 22. So that the breakage risk of the filter 23 is effectively reduced.

In at least one embodiment, the protrusion 212 and the first adhesive layer 22 are also used to prevent particles from falling on an image area of the substrate assembly 30.

In at least one embodiment, the first adhesive layer 22 may be a light-absorbing adhesive layer to absorb light, thereby reducing the intensity of the light at the edge of the substrate assembly 30, and reducing the scattered light of the camera device 100. So that the photographing effect of the camera device 100 may be improved.

In at least one embodiment, at least one opening 2121 penetrates the protrusion 212 along a direction perpendicular to the protruding direction of the protrusion 212 to balance the pressure inside the bearing seat 21 and the pressure outside the bearing seat 21.

The second adhesive layer 24 is arranged on the second side 21b of the bearing seat 21 facing away from the protrusion 212 to fix the adjusting mechanism 12 on the bearing base 21.

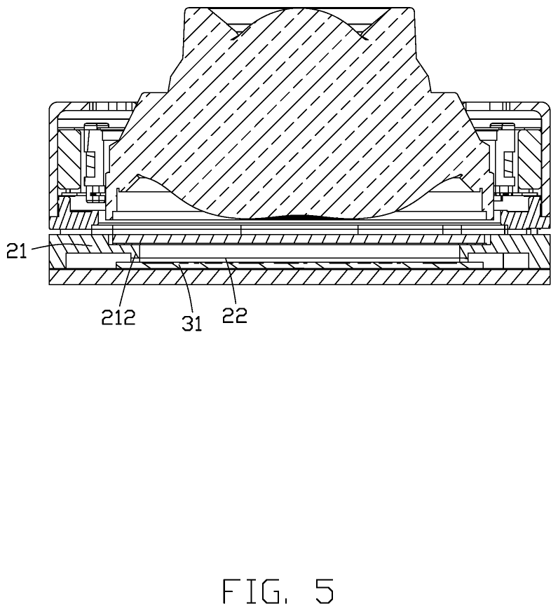

Referring to FIG. 3 and FIG. 5, the substrate assembly 30 includes a photosensitive chip 31, a circuit board 32, and a connector 33.

The photosensitive chip 31 is mounted on the circuit board 32 and located below the protrusion 212. The protrusion 212 is pressed against a periphery of the photosensitive chip 31 and connected to the periphery of the photosensitive chip 31 through the first adhesive layer 22. The periphery of the photosensitive chip 31 is non-imaging area.

The connector 33 is connected to the circuit board 32 and the main body 201.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A camera device comprising:
a lens assembly;
a substrate assembly; and
a bearing assembly comprising a bearing seat, a filter, and a first adhesive layer;
wherein a protrusion protrudes from a first side of the bearing seat, a second side of the bearing seat facing away from the first side of the bearing seat is connected to the lens assembly, a through groove penetrates the first side of the bearing seat and the second side of the bearing seat, the filter is received in the through groove, the first adhesive layer is formed on the protrusion to fix the protrusion on the substrate assembly.

2. The camera device of claim 1, wherein the through groove is a stepped groove and comprises a stepped surface, the filter is supported by the stepped surface.

3. The camera device of claim 2, wherein a gasket is sandwiched between the filter and the stepped surface.

4. The camera device of claim 2, wherein the through groove comprises a first recess recessed from the second side and a second recess recessed from the first side and communicating with the first recess, the stepped surface is connected to a first inner surface forming the first recess and a second inner surface forming the second recess, the filter is received in the first recess.

5. The camera device of claim 4, wherein the protrusion around the second recess protrudes from the first side along second inner surface forming the second recess in a direction away from the second side.

6. The camera device of claim 5, wherein at least one opening penetrates the protrusion along a direction perpendicular to a protruding direction of the protrusion.

7. The camera device of claim 1, wherein the first adhesive layer is a light-absorbing adhesive layer.

8. The camera device of claim 1, wherein the substrate assembly comprises a circuit board and a photosensitive chip mounted on the circuit board, the protrusion is pressed against a periphery of the photosensitive chip and connected to the periphery of the photosensitive chip through the first adhesive layer.

9. An electronic equipment comprising:
a main body;
a camera device received in the main body comprising:
a lens assembly;
a substrate assembly; and
a bearing assembly comprising a bearing seat, a filter, and a first adhesive layer;
wherein a protrusion protrudes from a first side of the bearing seat, a second side of the bearing seat facing away from the first side of the bearing seat is connected to the lens assembly, a through groove penetrates the first side of the bearing seat and the second side of the bearing seat, the filter is received in the through groove, the first adhesive layer is formed on the protrusion to fix the protrusion on the substrate assembly.

10. The electronic equipment of claim 9 wherein the through groove is a stepped groove and comprises a stepped surface, the filter is supported by the stepped surface.

11. The electronic equipment of claim 10, wherein a gasket is sandwiched between the filter and the stepped surface.

12. The electronic equipment of claim 10, wherein the through groove comprises a first recess recessed from the second side and a second recess recessed from the first side and communicating with the first recess, the stepped surface is connected to a first inner surface forming the first recess and a second inner surface forming the second recess, the filter is received in the first recess.

13. The electronic equipment of claim 12, wherein the protrusion around the second recess protrudes from the first side along second inner surface forming the second recess in a direction away from the second side.

14. The electronic equipment of claim 13, wherein at least one opening penetrates the protrusion along a direction perpendicular to a protruding direction of the protrusion.

15. The electronic equipment of claim 9, wherein the first adhesive layer is a light-absorbing adhesive layer.

16. The electronic equipment of claim 9, wherein the substrate assembly comprises a circuit board and a photosensitive chip mounted on the circuit board, the protrusion is pressed against a periphery of the photosensitive chip and connected to the periphery of the photosensitive chip through the first adhesive layer.
